(19) United States
(12) Patent Application Publication
(10) Pub. No.: US 2026/0142767 A1
(43) Pub. Date: May 21, 2026

(54) METHOD AND APPARATUS FOR PERFORMING INTERFERENCE PREDICTION IN WIRELESS COMMUNICATION SYSTEM

(71) Applicants: Samsung Electronics Co., Ltd., Gyeonggi-do (KR); UIF (University Industry Foundation), Yonsei University, Seoul (KR)

(72) Inventors: Soomin KIM, Gyeonggi-do (KR); Yonghwi KIM, Seoul (KR); Chanbyoung CHAE, Seoul (KR)

(21) Appl. No.: 19/395,752

(22) Filed: Nov. 20, 2025

(30) Foreign Application Priority Data
Nov. 21, 2024 (KR) 10-2024-0167761

(51) Int. Cl. H04L 5/00; H04W 24/10; H04W 36/00

(52) U.S. Cl. CPC H04L 5/0044; H04L 5/0048; H04W 24/10; H04W 36/0072

(57) ABSTRACT

The present disclosure relates to a 5^{th} generation (5G) or a 6^{th} generation (6G) communication system for supporting higher data rates beyond a 4^{th} generation (4G) communication system such as long term evolution (LTE). A method performed by a base station in a wireless communication system includes receiving an initial access-related signal from a first terminal, receiving an uplink (UL)-related signal from a second terminal, obtaining, by an interference prediction unit, predicted interference information based on the initial access-related signal and the UL-related signal, obtaining interference estimation configuration information for the first terminal and the second terminal based on the predicted interference information, and transmitting the interference estimation configuration information including the predicted interference information to the first terminal and the second terminal.

### CROSS-REFERENCE TO RELATED APPLICATION(S)

This application is based on and claims priority under 35 U.S.C. § 119 to Korean Patent Application No. 10-2024-0167761, filed on Nov. 21, 2024, in the Korean Intellectual Property Office, the disclosure of which is incorporated herein by reference in its entirety.

### BACKGROUND

### 1. Field

The disclosure relates generally to a wireless communication system, and more particularly, to a method and apparatus for performing interference prediction in a wireless communication system.

### 2. Description of the Related Art

Given the prolific development of wireless communication, technologies have been developed mainly for services targeting humans, such as voice calls, multimedia services, and data services. Since the commercialization of 5th-generation (5G) communication systems, it is expected that the number of connected devices will exponentially grow and be increasingly connected to communication networks. Examples of things connected to networks may include vehicles, robots, drones, home appliances, displays, smart sensors connected to various infrastructures, construction machines, and factory equipment.

Mobile devices are expected to evolve in various form-factors, such as augmented reality (AR) glasses, virtual reality (VR) headsets, and hologram devices. To provide various services by connecting hundreds of billions of devices and things in the 6th-generation (6G) era, there have been ongoing efforts to develop improved 6G communication systems. For these reasons, 6G communication systems are referred to as beyond-5G systems. 6G communication systems, which are expected to be commercialized around 2030, will have a peak data rate of tera (1,000 giga)-level bits per second (bps) and a radio latency less than 100 microseconds (psec). That is, a data rate in 6G communication systems is 50 times higher than that in 5G communication systems, and a wireless latency time is reduced to 1/10.

To accomplish such a high data rate and an ultra-low latency, it has been considered to implement 6G communication systems in a terahertz (THz) band (e.g., 95 gigahertz (GHz) to 3 THz bands). It is expected that, due to more severe path loss and atmospheric absorption in the THz bands than those in millimeterwave (mmWave) bands introduced in 5G, technologies capable of securing the signal transmission distance (i.e., coverage) will become more vital. It is necessary to develop, as major technologies for securing such coverage, radio frequency (RF) elements, antennas, novel waveforms having improved coverage than orthogonal frequency division multiplexing (OFDM), beamforming and massive multiple input multiple output (MIMO), full dimensional MIMO (FD-MIMO), array antennas, and multiantenna transmission technologies such as large-scale antennas. In addition, there has been ongoing discussion on new technologies for improving the coverage of THz-band signals, such as metamaterial-based lenses and antennas, high-dimensional spatial multiplexing using orbital angular momentum (OAM), and reconfigurable intelligent surface (RIS).

Moreover, to improve the spectral efficiency and the overall network performances, the following technologies have been developed for 6G communication systems: a full-duplex technology for enabling an uplink (UL) transmission and a downlink (DL) transmission to simultaneously use the same frequency resource, a network technology for utilizing satellites, high-altitude platform stations (HAPS), and the like in an integrated manner, an improved network structure for supporting mobile base stations (BSs) and the like and enabling network operation optimization and automation and the like, a dynamic spectrum sharing technology via collision avoidance based on a prediction of spectrum usage, an artificial intelligence (AI)-based communication technology for system optimization by utilizing AI from a designing phase for developing 6G and internalizing end-to-end AI support functions, and a next-generation distributed computing technology for realizing high-complexity services exceeding the limit of user equipment (UE) computing ability by utilizing super-high-performance communication and computing resources (such as mobile edge computing (MEC), clouds, and the like). In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive extended reality (XR), high-fidelity mobile hologram, and digital replica could be provided through 6G communication systems. In addition, services such as remote surgery, industrial automation, and emergency response, for security and reliability enhancement, will be provided through the 6G communication systems and could be applied in various fields such as industry, medical care, automobiles, and home appliances.

### SUMMARY

An aspect of the disclosure is to provide an apparatus and a method for increasing UE performance and decreasing interference and overhead by improved interference determination.

According to an aspect of the disclosure, a method performed by a BS in a wireless communication system may include receiving an initial access-related signal from at least one first terminal. The method may include receiving a UL-related signal from at least one second terminal. The method may include obtaining, by an interference prediction unit, predicted interference information based on the initial access-related signal and the UL-related signal. The method may include obtaining interference estimation configuration information for the first terminal and the second terminal based on the predicted interference information. The method may include transmitting the interference estimation configuration information including the predicted interference information to the first terminal and the second terminal.

According to an aspect of the disclosure, a BS in a wireless communication system may include a transceiver. The BS may include at least one processor coupled to the transceiver. The at least one processor may be configured to receive an initial access-related signal from at least one first terminal. The at least one processor may be configured to receive a UL-related signal from at least one second terminal. The at least one processor may be configured to obtain, by an interference prediction unit, predicted interference information based on the initial access-related signal and the UL-related signal. The at least one processor may be configured to obtain interference estimation configuration information for the first terminal and the second terminal based on the predicted interference information. The at least one processor may be configured to transmit the interference estimation configuration information including the predicted interference information to the first terminal and the second terminal.

According to an aspect of the disclosure, a method performed by a first terminal in a wireless communication system may include transmitting an initial access-related signal to a BS. The method, wherein predicted interference information may be obtained by an interference prediction unit in the BS based on the initial access-related signal and a UL-related signal transmitted from a second terminal, and interference estimation configuration information for the first terminal and the second terminal may be obtained in the BS based on the predicted interference information The method may include receiving the interference estimation configuration information including the predicted interference information from the BS.

According to an aspect of the disclosure, a first terminal in a wireless communication system may include a transceiver. The first terminal may include at least one processor coupled to the transceiver. The at least one processor may be configured to transmit an initial access-related signal to a BS. The first terminal, wherein predicted interference information may be obtained by an interference prediction unit in the BS based on the initial access-related signal and a UL-related signal transmitted from a second terminal, and interference estimation configuration information for the first terminal and the second terminal may be obtained in the BS based on the predicted interference information. The at least one processor may be configured to receive the interference estimation configuration information including the predicted interference information from the BS.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates interference in a full duplex (FD) network, according to an embodiment;

FIG. 2A illustrates a BS and a UE related to interference estimation overhead in an FD network, according to an embodiment;

FIGS. 2B and 2C illustrate a method of a BS and a UE, according to an embodiment;

FIG. 3A illustrates a UE scheduling method, according to an embodiment;

FIG. 3B illustrates a UE scheduling method, according to an embodiment;

FIGS. 4A, 4B, and 4C illustrate interference information prediction in an FD network, according to an embodiment;

FIGS. 5A and 5B illustrate a method of a UE and a BS including an interference prediction unit, according to an embodiment;

FIGS. 6A and 6B illustrate an interference estimation situation, according to an embodiment;

FIG. 7 illustrates an interference estimation method of a BS and a UE, according to an embodiment;

FIGS. 8A and 8B illustrate an interference prediction method related to handover, according to an embodiment;

FIG. 9 illustrates an interference estimation simulation result, according to an embodiment;

FIG. 10 illustrates a configuration of a BS, according to an embodiment; and

FIG. 11 illustrates a configuration of a UE, according to an embodiment.

### DETAILED DESCRIPTION

Embodiments of the disclosure will be described in detail with reference to the accompanying drawings.

Descriptions of techniques that are well known in the art and not directly related to the disclosure are omitted for the sake of clarity and conciseness.

For the same reasons, some elements are exaggerated, omitted, or schematically illustrated in the attached drawings. The size of each element may not substantially reflect its actual size. In each drawing, the same or corresponding element is denoted by the same reference numeral.

The advantages and features of the disclosure, and methods of achieving the same, will become apparent with reference to embodiments of the disclosure described below in detail in conjunction with the accompanying drawings. The disclosure may, however, be embodied in many different forms and should not be construed as limited to embodiments of the disclosure set forth herein; rather these embodiments of the disclosure are provided so that this disclosure will be thorough and complete, and will fully convey the scope of the disclosure to one of ordinary skill in the art. Herein, the same reference numerals may denote the same elements.

The terms used herein are those defined in consideration of functions in the disclosure, and may vary according to the intention of users or operators, precedents, etc.

Hence, the terms used herein should be defined based on the meaning of the terms together with the descriptions throughout the specification.

It will be understood that when a certain part “includes” a certain component, the part does not exclude another component but may further include another component, unless the context clearly dictates otherwise. The term “ . . . unit” or “ . . . module” refers to an entity that performs at least one function or operation, and the unit may be implemented as hardware or software or as a combination of hardware and software.

In addition, the expression ‘at least one of a, b, and c’ indicates only a, only b, only c, both a and b, both a and c, both b and c, or all of a, b, and c.

Hereinafter, a BS is an entity that allocates resources to a UE and may be at least one of a gNode B, an eNode B, a node B, a radio access unit, a BS controller, or a node on a network. A terminal may include a UE, a mobile station (MS), a cellular phone, a smartphone, a computer, or a multimedia system capable of performing a communication function. A DL refers to a wireless transmission path of a signal to be transmitted from a BS to a terminal, and a UL refers to a wireless transmission path of a signal to be transmitted from a terminal to a BS. While embodiments of the disclosure are described by using a long-term evolution (LTE) or LTE-advanced (LTE-A) system as an example, the embodiments of the disclosure may also be applied to other communication systems having a similar technical background or channel form. For example, such communication systems may include 5^{t}h generation mobile communication systems (e.g., 5G or new radio (NR) systems) developed after LTE-A, and 5G in the following description may be a concept including existing LTE, LTE-A, and other similar services. The disclosure may be applied to other communication systems through some modifications without departing from the scope of the disclosure at the discretion of one of ordinary skill in the art.

The term . . . unit used herein refers to a software or hardware component, such as a field-programmable gate array (FPGA) or an application-specific integrated circuit (ASIC), which performs certain tasks. However, the term . . . unit does not mean to be limited to software or hardware. A . . . unit may be configured to be in an addressable storage medium or may be configured to operate one or more processors. Accordingly, a . . . unit may include, by way of example, components, such as software components, object-oriented software components, class components, and task components, processes, functions, attributes, procedures, subroutines, segments of program code, drivers, firmware, microcode, circuitry, data, databases, data structures, tables, arrays, and variables. The functionality provided in components and . . . units may be combined into fewer components and . . . units or may be further separated into additional components and . . . units. Furthermore, components and . . . units may be implemented to operate one or more central processing units (CPUs) in a device or a secure multimedia card. A . . . unit in an embodiment may include one or more processors.

For convenience of explanation below, the terms and names defined in 5G and 6G standards, which are standards defined by the 3^{rd} generation partnership project (3GPP) organizations among currently existing communication standards, are used. However, the disclosure is not limited to the terms and names, and may also be applied to wireless communication networks following other standards.

The terms used herein are those defined in consideration of functions in the disclosure, and may vary according to the intention of users or operators, precedents, etc.

Hence, the terms used herein should be defined based on the meaning of the terms together with the descriptions throughout the specification. Hereinafter, terms for identifying access nodes or indicating network entities, messages, interfaces between network entities, and various identification information used herein are exemplified for convenience of explanation. Accordingly, the disclosure is not limited to the terms as herein used, and may use different terms to refer to the items having the same meaning in a technological sense.

For a 5G mobile communication service, additional coverage extension technology was introduced compared to an LTE communication service, but the actual coverage of the 5G mobile communication service may generally use a time division duplex (TDD) system suitable for a service with a high downlink traffic proportion. Also, as a center frequency is increased to increase a frequency band, a coverage of a base station and a terminal is reduced, and thus, coverage enhancement is a core requirement of the 5G mobile communication service. In particular, because transmission power of a terminal is generally lower than transmission power of a base station, it is necessary to support a service with a high downlink traffic proportion, and because a ratio of downlink in a time domain is higher than that of uplink, coverage enhancement of an uplink channel is a core requirement of the 5G mobile communication service. Examples of a method of physically enhancing the coverage of an uplink channel between a base station and a terminal may include a method of increasing a time resource of the uplink channel, a method of reducing a center frequency, and a method of increasing transmission power of the terminal. However, changing a frequency may have a limitation because a frequency band is determined for each network operator. Also, increasing maximum transmission power of the terminal may have a limitation because a maximum value is determined to reduce interference, that is, maximum transmission power of the terminal is determined by regulations or rules.

Accordingly, for coverage enhancement of the base station and the terminal, uplink and downlink resources may be divided even in a frequency domain as in a frequency division duplex (FDD) system, rather than dividing uplink and downlink resources in a time domain according to traffic proportions of uplink and downlink in a TDD system. In an embodiment of the disclosure, a system for flexibly dividing uplink and downlink resources in a time domain and a frequency domain may be referred to as an XDD system, a flexible TDD system, a hybrid TDD system, a TDD-FDD system, a hybrid TDD-FDD system, a subband full duplex system, or a full duplex (FD) system, and the disclosure is not limited to the above examples. X in XDD may denote a time or a frequency.

In an FD scheme, an entire frequency band may be allocated as uplink and downlink resources at the same time, and in this case, the FD scheme is referred to as inband full duplex (IBFD). In the FD scheme, at the same time, a portion of the frequency band may be allocated as uplink resources and another portion may be allocated as downlink resources, and in this case, the FD scheme is referred to as subband FD (SBFD) or cross division duplex (XDD). Hereinafter, a wireless communication system supporting a TDD scheme and/or an FD scheme will be described as an example of a system supporting various multiplexing schemes. For example, a system in which a BS supports an FD scheme capable of simultaneously performing transmission and reception and a terminal supports a half duplex scheme capable of performing either transmission or reception but not both simultaneously will be described. However, it should be noted that the embodiments of the disclosure described below may be applied in the same manner to a wireless communication system supporting configuration of flexible (F) slots, regardless of whether the FD scheme is supported. The embodiments of the disclosure may be applied not only to a 5G system but also to a next-generation system beyond 5G (e.g., a 6G system).

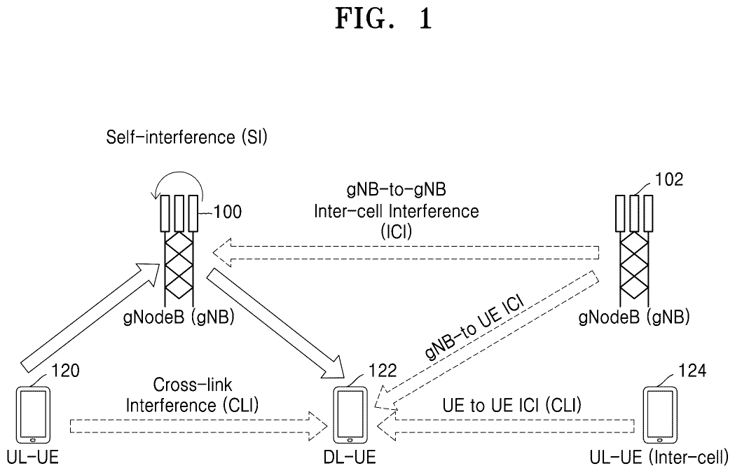

FIG. 1 illustrates interference in an FD network, according to an embodiment.

Various types of interference acting on a BS and a UE in an FD network will be described with reference to FIG. 1. For example, FD may be flexible duplex, and the flexible duplex may include cross division duplex (XDD) and IBFD. FD enables the UL and DL to freely overlap.

For example, when FD is applied to mobile communication, a BS (e.g., gNodeB or gNB) capable of FD operation may simultaneously serve UL and DL to a UE capable of only half duplex (HD) operation. For example, IBFD may be performed on specific resources. For example, a gNB transmitter Tx may serve DL, and a gNB receiver Rx may serve UL.

Referring to FIG. 1, in a network to which FD is applied, various types of interference, for example, self-interference (SI), CLI, and ICI, may occur. For example, inter-node interference (INI) may be CLI and/or ICI.

For example, SI may occur when a DL signal of the transmitter Tx of a gNB 100 is also received by the receiver Rx of the gNB 100 and acts as interference to UL communication. Various types of SI cancellation (SIC) methods may be used to remove such SI. For example, analog SIC based on circuit and antenna technology or digital SIC based on signal processing may be used.

For example, CLI is interference between UEs, and may occur when a signal transmitted by a UL-UE 120 to the gNB 100 acts as interference to a DL-UE 122. For example, a signal transmitted by a UL-UE 124 of an adjacent cell to a gNB 102 may act as CLI to the DL-UE 122. A CLI value may vary according to which UL-UE is activated. For example, a UL-UE may be activated upon receiving a UL grant from a BS.

For example, ICI may occur when the gNB 102 of the adjacent cell acts as interference to the DL-UE 122 of the current cell. For example, ICI may occur when the gNB 102 of the adjacent cell acts as interference to the gNB 100 of the current cell. For example, ICI may occur when the UL-UE 124 of the adjacent cell acts as interference to the DL-UE 122 of the current cell.

INI may degrade the signal-to-interference-plus-noise ratio (SINR) performance of the receiver Rx of the gNB 100 or 102 or the DL-UE 122. Accordingly, it is necessary to identify INI and utilize the INI for scheduling to minimize performance degradation. Unlike SI, it is difficult to cancel CLI actively (based on a transmitted signal), making it necessary to cancel the CLI by scheduling a UE so that the strength of a channel through which the CLI passes is minimized. This is because a signal transmitted by the UE causing the CLI should be identified, which requires cooperation between UEs. Accordingly, in resources serving IBFD, appropriate pairing of a DL-UE and a UL-UE based on the CLI channel strength between UEs should be performed to ensure performance.

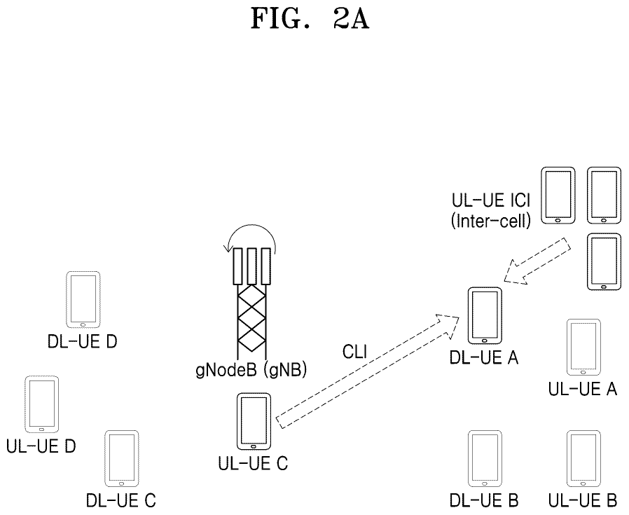

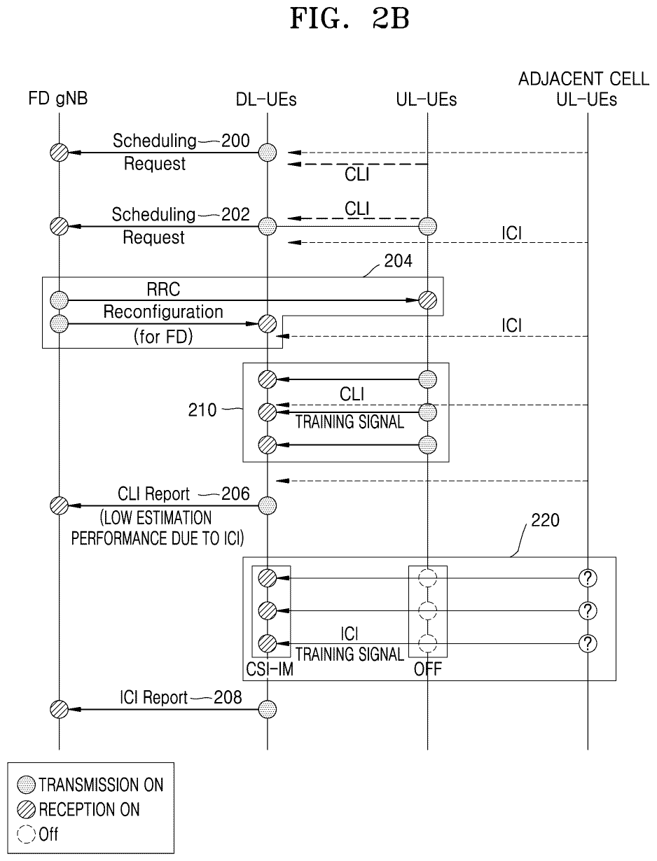

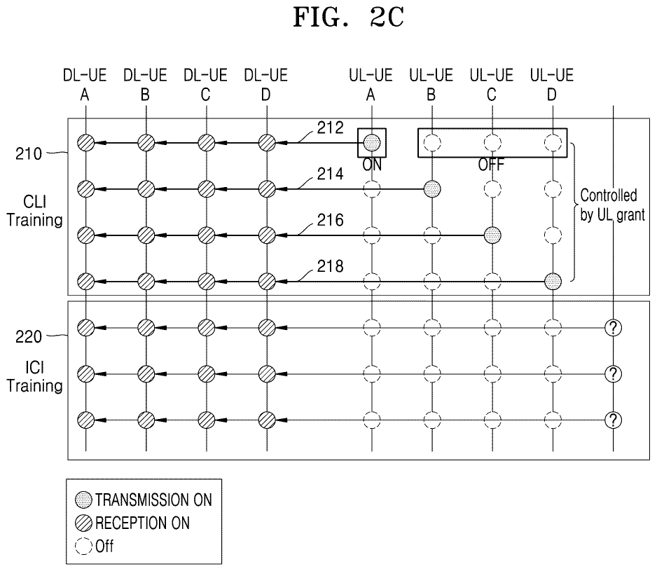

FIG. 2A illustrates a BS and a UE related to interference estimation overhead in an FD network, according to an embodiment.

Referring to FIG. 2A and Table 1 shown below, interference estimation overhead in an FD network in relation to a BS and a UE will be described.

TABLE 1

| | DL | UL | Overhead |
|---|---|---|---|
| DL channel estimation | On | Off | N_{DL} |
| UL channel estimation | Off | On | N_{UL} |
| SIC estimation | On | Off | 1 |
| Intra-cell CLI | Off | On | N_{UL} |
| estimation | | | |
| UE to UE ICI estimation | off | off | N_{DL} |

During a process of estimating interference (e.g., CLI and ICI), DL and UL may be configured in an On/Off scheme. For example, NDL may denote the number of DL users, and NUL may denote the number of UL users. For example, regarding the On/Off scheme, non-zero power channel state information reference signal (NZP-CSI-RS) and zero power CSI-RS (ZP-CSI-RS) schemes may be used from a gNB perspective. As used herein, NZP-CSI-RS may refer to a CSI reference signal transmitted with non-zero power for downlink channel measurement and CSI acquisition by a UE. As used herein, ZP-CSI-RS may refer to a CSI reference signal configuration in which the corresponding resources are muted (zero power) to provide interference-free resources or measurement references for a UE. For example, pilot signals including a sounding reference signal (SRS) and a demodulation reference signal (DMRS) are used as signals transmitted by a UE. Herein, a pilot signal may be transmitted by a UE to estimate interference.

In DL channel estimation, it may be beneficial that UL-UEs do not transmit signals and only DL-UEs communicate. For example, DL-UE A, DL-UE B, DL-UE C, and DL-UE D may be in an On state, and UL-UE A, UL-UE B, UL-UE C, and UL-UE D may be in an Off state. For example, the On state may be when a signal is being transmitted, and the Off state may be an idle state in which no signal is being transmitted. In this case, interference estimation overhead may be proportional to the number of DL-UEs (e.g., NDL=4).

In UL channel estimation, it may be beneficial that DL-UEs do not transmit signals and only UL-UEs communicate. For example, DL-UE A, DL-UE B, DL-UE C, and DL-UE D may be in an Off state, and UL-UE A, UL-UE B, UL-UE C, and UL-UE D may be in an On state. For example, the On state may be when a signal is being transmitted, and the Off state may be an idle state in which no signal is being transmitted. In this case, interference estimation overhead may be proportional to the number of UL-UEs (e.g., NuL=4).

In SIC estimation, when a DL signal is in an On state and a UL signal is in an On state, an SI signal and the UL signal are mixed and received by the gNB, which may be disadvantageous in estimating only an SI channel. Accordingly, the UL signal may be in an Off state. For example, in DL channel estimation, estimation should be performed for four DLs of DL-UE A, DL-UE B, DL-UE C, and DL-UE D, but in SI, only one link needs to be estimated and thus, interference estimation overhead may be “1”.

In intra-cell CLI estimation, when the gNB transmits a DL signal and a UL-UE transmits a pilot signal, it may be disadvantageous for estimating CLI that may occur within a cell. Accordingly, a UL signal may be in an On state, and the DL signal may be in an Off state. For example, DL Off may indicate that the gNB is not transmitting a signal. For example, DL-UE A, DL-UE B, DL-UE C, and DL-UE D may be in an Off state, and UL-UE A, UL-UE B, UL-UE C, and UL-UE D may be in an On state. In this case, interference estimation overhead may be proportional to the number of UL-UEs (e.g., NuL=4).

In UE to UE ICI estimation, a DL-UE may estimate interference from an adjacent cell UL-UE. In this case, a UL signal may be an Off state, and a DL signal may also be in an Off state. For example, estimation may be performed for DL-UE A, DL-UE B, DL-UE C, and DL-UE D. In this case, interference estimation overhead may be proportional to the number of DL-UEs (e.g., NDL=4). Accordingly, as described with reference to FIG. 2A and Table 1, interference estimation overhead may be proportional to the number of users, and interference estimation overhead may increase as the number of users increases.

FIGS. 2B and 2C illustrate a method of a BS and a UE, according to an embodiment.

Referring to FIG. 2B, a wireless communication system may include an FD gNB, at least one DL-UE, at least one UL-UE, and at least one adjacent cell UL-UE. The FD gNB may receive a scheduling request from the at least one DL-UE (200). The FD gNB may receive a scheduling request from the at least one UL-UE (202). The FD gNB may transmit radio resource control (RRC) reconfiguration to the at least one DL-UE and the at least one UL-UE transmitting the scheduling request (204). The at least one UL-UE receiving the RRC reconfiguration may transmit a CLI training signal to the at least one DL-UE (210). For example, the CLI training signal may be a signal for estimating CLI, such as an SRS or a DMRS.

The at least one DL-UE receiving the CLI training signal for interference estimation may transmit a CLI report to the FD gNB (206). For example, transmitting the CLI report may indicate that the DL-UE transmits an interference measurement report. In this case, because there is also ICI from the at least one adjacent cell UL-UE, CLI estimation performance may be low.

The at least one DL-UE may receive a signal transmitted by the at least one adjacent cell UL-UE as an ICI training signal (220). For example, the ICI training signal may be a signal for estimating ICI. For example, the DL-UE receiving the ICI training signal may estimate interference by using a CSI-interference measurement (CSI-IM) method.

The at least one DL-UE receiving the ICI training signal for interference estimation may transmit an ICI report to the FD gNB (208). For example, transmitting the ICI report may indicate that the DL-UE transmits an interference measurement report.

Referring to FIG. 2C in relation to operation 210, CLI training may be a process in which the UL-UE transmits a CLI training signal to the DL-UE. The CLI training signal may be an SRS or a DMRS. The UL-UE transmitting a signal may be in an ON state, and the UL-UE not transmitting a signal may be in an OFF state. ON may indicate that the UL-UE receives a UL grant from the FD gNB. OFF may indicate that the UL-UE does not receive a UL grant from the FD gNB.

UL-UE A may transmit a CLI training signal for interference estimation to DL-UE A, DL-UE B, DL-UE C, and DL-UE D (212). In this case, UL-UE A may be in an ON state, and UL-UE B, UL-UE C, and UL-UE D may be in an OFF state.

UL-UE B may transmit a CLI training signal for interference estimation to DL-UE A, DL-UE B, DL-UE C, and DL-UE D (214). In this case, UL-UE B may be in an ON state, and UL-UE A, UL-UE C, and UL-UE D may be in an OFF state.

UL-UE C may transmit a CLI training signal for interference estimation to DL-UE A, DL-UE B, DL-UE C, and DL-UE D (216). In this case, UL-UE C may be in an ON state, and UL-UE A, UL-UE B, and UL-UE D may be in an OFF state.

UL-UE D may transmit a CLI training signal for interference estimation to DL-UE A, DL-UE B, DL-UE C, and DL-UE D (218). In this case, UL-UE D may be in an ON state, and UL-UE A, UL-UE B, and UL-UE C may be in an OFF state.

In operation 210, interference estimation may be performed by turning ON one UL-UE and turning OFF the remaining UL-UEs. However, as the number of UEs increases, interference estimation overhead may increase exponentially.

Referring to FIG. 2C in relation to operation 220, ICI training may be a process in which the DL-UE receives a signal transmitted by an adjacent cell gNB and/or the adjacent cell UL-UE as an ICI training signal. For example, the DL-UE receiving the ICI training signal may estimate interference by using a CSI-IM method. In this case, the at least one UL-UE may be in an OFF state.

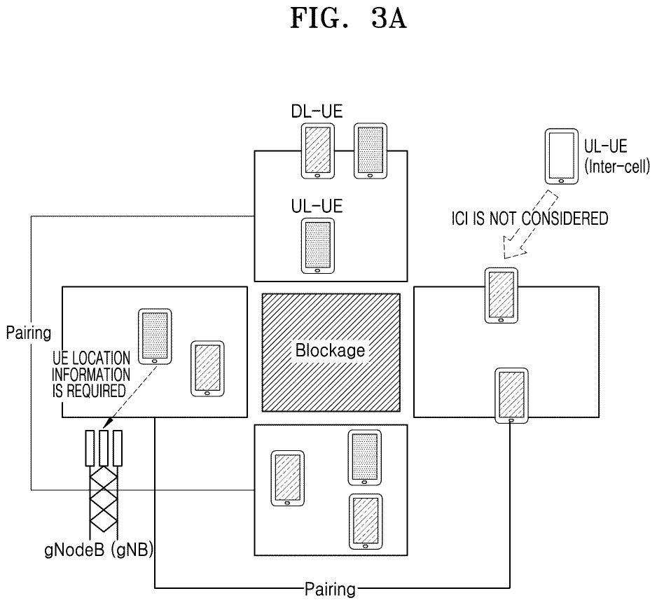

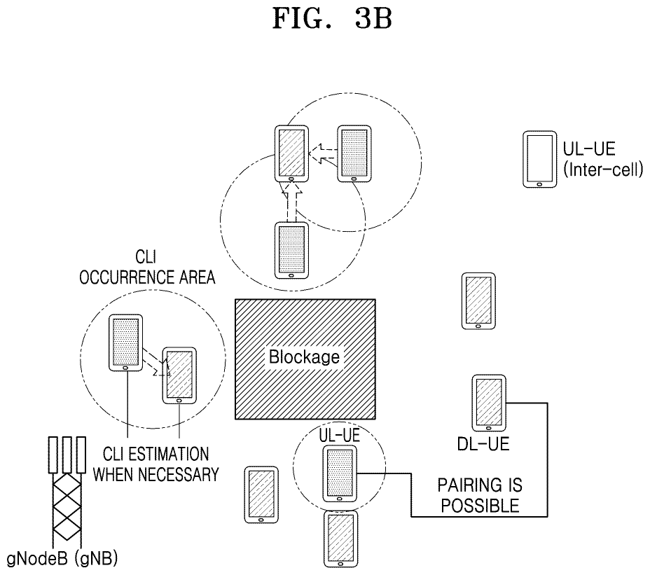

FIG. 3A illustrates a UE scheduling method, according to an embodiment.

Referring to FIG. 3A, a DL-UE and a UL-UE may be paired based on UE location information and blockage information within a cell. For example, CLI may not occur between UEs at sites located on opposite sides of a blockage. For example, a gNB may perform scheduling by pairing a DL-UE and a UL-UE located on opposite sides of the blockage.

This method requires actual location information of UEs and geographical context, and considers CLI but may not consider ICI. This method may divide zones based only on the presence of CLI rather than considering an actual strength (level) of CLI. When the DL-UE and the UL-UE are located close to each other (e.g., within a proximity in which inter-cell interference or mutual coupling is likely to occur based on network-configured or implementation-specific criteria), this method may not be effective if there is a CLI-free pair in the same zone. This method may be understood based on documents related to the disclosure including (M. Duarte, et al., “Inter-user interference coordination in full-duplex systems based on geographical context information,” IEEE ICC, 2016) and (M. Duarte, et al., “Apparatus and method for full-duplex communication,” WO2017025139A1, Feb. 16, 2017). The related documents may be hereby incorporated by reference.

Referring to the patent related to the disclosure (N. Bhushan, et al., “Full duplex operation in a wireless communication network,” US91120606B2, Aug. 16, 2016), in an FD scheduling situation, a method of calculating CLI path-loss by using an estimation pilot or location information and then reflecting the CLI path-loss in scheduling was applied. When the calculated path-loss does not exceed a specific threshold, that is, when a CLI level is sufficiently low, two UEs are paired and scheduled. Also, a process of transmitting and receiving an “interference discovery signal” between UEs is used to check a level of CLI and reflect the same in UE pairing. The related document may be hereby incorporated by reference.

The methods disclosed in the related documents may have problems in that only CLI occurring within a cell is estimated, failing to sufficiently consider the influence of ICI, or CLI (ICI) is estimated only for a limited number of interference-causing nodes, making it unsuitable for situations where multiple UEs cause interference. In more detail, the methods disclosed in the related documents utilize information such as path-loss or blockage, which may indirectly estimate CLI. The methods have limitations in that they have lower performance compared to accurate CLI estimation and lack a backup process to compensate for incorrectly estimated information. Also, although the “interference discovery signal” is defined in the related documents, when multiple UEs should be simultaneously served, this method may cause high overhead and thus need improvement.

FIG. 3B illustrates a UE scheduling method, according to an embodiment.

Referring to FIG. 3B, a gNB may perform estimation for an area where CLI may exist through training. A DL-UE within a CLI occurrence area may perform CLI estimation when necessary. Through the CLI estimation, the accuracy of CLI measurement may be improved and ICI may be considered. In CLI estimation, communication protocol signals such as an SRS and an initial access-related signal may be used. Interference information may be pre-estimated or predicted based on relative location information within a cell or approximate location information of a DL-UE or a UL-UE. Additional performance improvement of interference estimation may be possible by obtaining actual location information of the UE. When pre-estimation or prediction is insufficient and additional interference estimation is required, more accurate interference information may be obtained through a pilot signal for interference measurement. Scheduling for the DL-UE and the UL-UE may be performed based on the interference information.

In an FD multi-cell environment in which CLI and ICI coexist, overhead occurring during a process of estimating the CLI and the ICI may be reduced, and thus, FD network scheduling performance may be improved. By utilizing UL and DL communication signals and a pre-optimized AI model capable of identifying interference suitable for a cell environment, FD scheduling may be performed while improving estimation accuracy of CLI and ICI and reducing overhead.

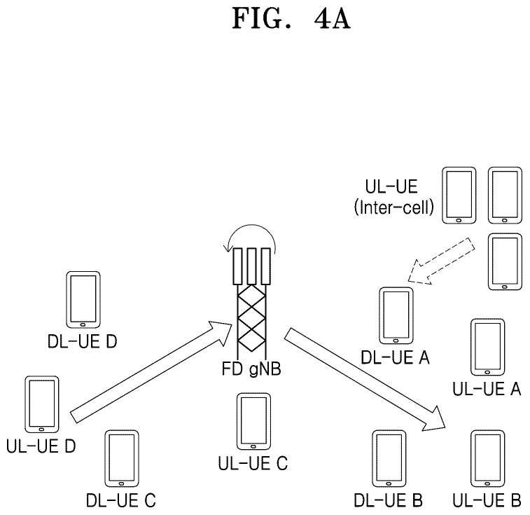

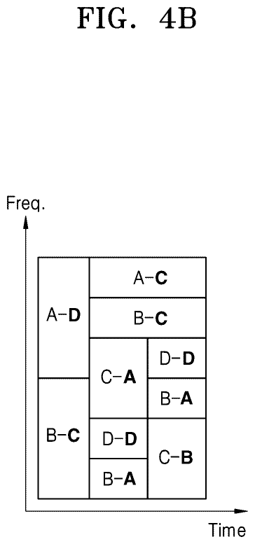

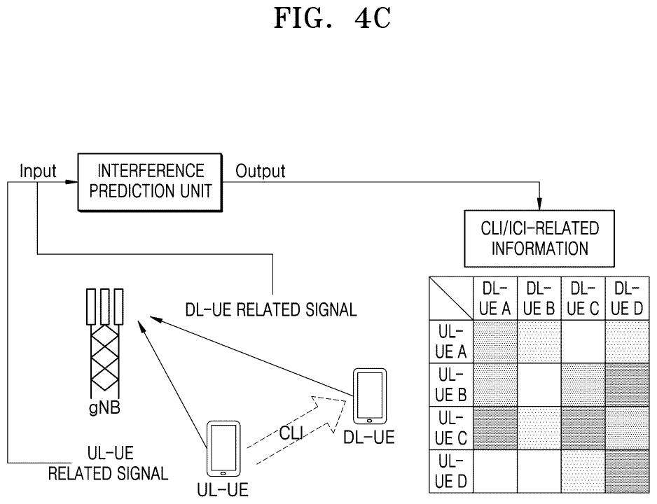

FIGS. 4A, 4B, and 4C illustrate interference information prediction in an FD network, according to an embodiment.

Referring to FIG. 4A, a wireless communication system may include an FD gNB, at least one DL-UE (e.g., DL-UE A, DL-UE B, DL-UE C, and DL-UE D), at least one UL-UE (e.g., UL-UE A, UL-UE B, UL-UE C, and UL-UE D), and at least one adjacent cell (inter-cell) UL-UE. The FD gNB may support HD UEs. An HD UE may be a DL-UE or a UL-UE. For resources serving IBFD, the FD gNB may pair a DL-UE and a UL-UE in each resource.

Referring to FIG. 4B, because the wireless communication system is an FD network, UL resources and DL resources may be flexibly divided in a time domain and a frequency domain. For example, a portion of a frequency band may be allocated as UL resources, and concurrently, another portion may be allocated as DL resources. For example, a portion of the frequency band may be concurrently allocated to DL-UE A and UL-UE D to be paired. For example, some frequency bands may be concurrently allocated to DL-UE B and UL-UE C to be paired.

Referring to FIG. 4C, the gNB may include an interference prediction unit which may be an AI model. The interference prediction unit may be implemented as a mathematical model.

A predefined operation rule or AI model is created through training, in which case the predefined operation rule or the AI model is established by training a basic AI model using a plurality of training data according to a learning algorithm to perform a desired feature (or objective). Such training may be performed by a device itself in which AI is performed as described herein or by a separate server and/or system. Examples of the learning algorithm may include, but are not limited to, machine learning, supervised learning, unsupervised learning, semi-supervised learning, and reinforcement learning.

The AI model may include a plurality of neural network layers having a plurality of weight values, and a neural network operation is performed through an operation between an operation result of a previous layer and the plurality of weight values. The plurality of weight values of the plurality of neural network layers may be optimized by a result of training the AI model. For example, the plurality of weight values may be updated to reduce or minimize a loss value or a cost value obtained by the AI model during a training procedure. An artificial neural network may include a deep neural network (DNN), and may include, but is not limited to, a convolutional neural network (CNN), a DNN, a recurrent neural network (RNN), a restricted Boltzmann machine (RBM), a deep belief network (DBN), a bidirectional recurrent deep neural network (BRDNN), or a deep Q-network.

The interference prediction unit may receive a DL-UE related signal and/or a UL-UE related signal. For example, the DL-UE related signal may include initial access-related information, and a signal transmitted and received between the gNB and the DL-UE in a previous time slot. The UL-UE related signal may include an SRS for UL channel estimation, a random access channel (RACH), initial access-related information, and a signal transmitted and received between the gNB and the UL-UE in a previous time slot.

The interference prediction unit may be trained through regression analysis of an artificial neural network. The interference prediction unit may receive data reflecting information of the DL-UE and/or the UL-UE and may pre-estimate interference (CLI, ICI) related information. The interference prediction unit may be trained and optimized by receiving an SRS, a DMRS, and an initial access signal, which are RRC signals used in communication. The interference prediction unit may be trained and optimized by receiving data that may reflect UE characteristics, such as angle of arrival (AoA), angle of departure (AoD), MIMO channel angle information, sensing information through integrated sensing and communication (ISAC), and vision information (e.g., satellite images and gNB camera images). The interference prediction unit may be trained on a correlation between a cell site-specific environment and a location of a UE, which determines a CLI value.

The interference prediction unit may output interference related information or predicted interference information through interference pre-estimation or interference information prediction. The interference related information or the predicted interference information may indicate a degree of interference between the DL-UE and the UL-UE using a CLI map/channel. Referring to the CLI map/channel in the drawing, a degree of interference between DL-UE D and UL-UE B may be stronger than a degree of interference between DL-UE C and UL-UE B. A degree of interference between DL-UE C and UL-UE B may be stronger than a degree of interference between DL-UE D and UL-UE A. A degree of interference between DL-UE D and UL-UE A may be stronger than a degree of interference between DL-UE C and UL-UE A.

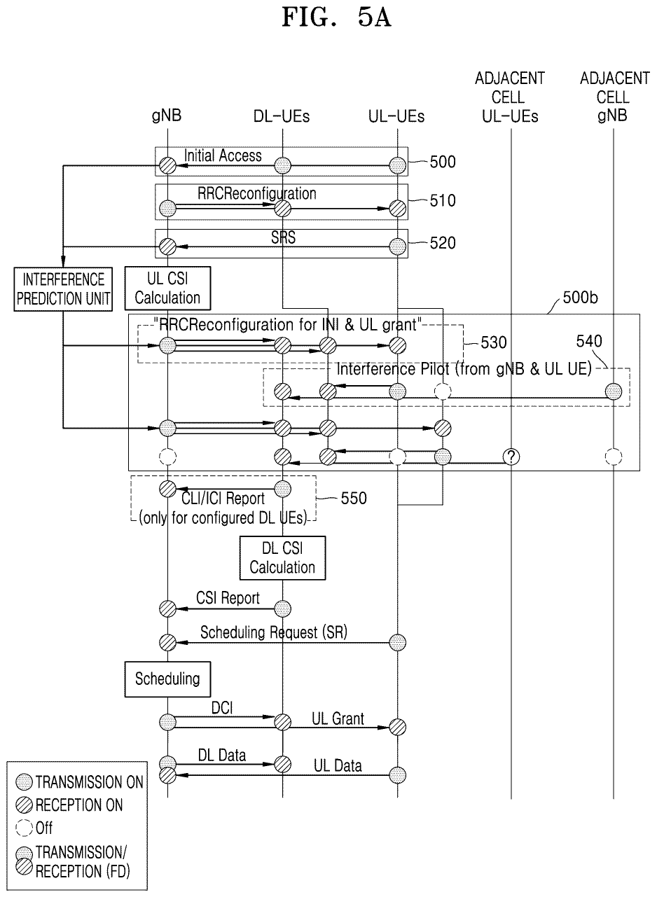

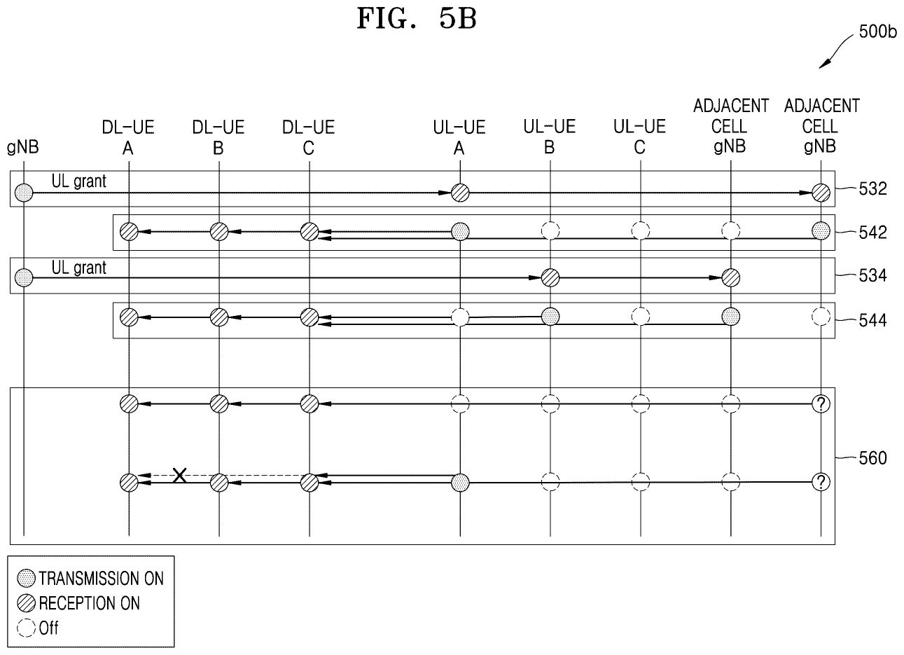

FIGS. 5A and 5B illustrate a method of a UE and a BS including an interference prediction unit, according to an embodiment.

Referring to FIG. 5A, a wireless communication system may include a gNB, an interference prediction unit, at least one DL-UE, at least one UL-UE, at least one adjacent cell UL-UE, and at least one adjacent cell gNB. The gNB may include the interference prediction unit.

The gNB may receive an initial access-related signal from the at least one DL-UE and/or the at least one UL-UE (500). The initial access-related signal may be a signal used by the gNB and the UE to perform initial access. The initial access may be performed through beam sweeping. The gNB may receive a DL-related signal from the at least one DL-UE. The gNB may transmit RRC reconfiguration to the at least one DL-UE and/or the at least one UL-UE (510). The gNB may receive a UL-related signal from the at least one UL-UE (520). The UL-related signal may include an SRS.

The interference prediction unit may receive data reflecting information of the UE and may pre-estimate interference information by using an AI model or a mathematical model. The interference prediction unit may obtain predicted interference information by using the AI model or the mathematical model based on the initial access-related signal or the UL-related signal received from the UE. The predicted interference information may include information about at least one of CLI, ICI, or INI. The gNB may obtain interference estimation configuration information for the DL-UE and/or the UL-UE based on the predicted interference information.

The gNB may predict an approximate value (e.g., a range) of interference through the interference prediction unit, and may transmit a signal (e.g., SRS/DMRS) and CSI-IM configuration for accurate interference estimation via RRC reconfiguration and/or UL grant to at least one UE (530). The gNB may transmit the interference estimation configuration information via RRC reconfiguration to the DL-UE and/or the UL-UE. The interference estimation configuration information may include the predicted interference information pre-estimated by the interference prediction unit by using the AI model or the mathematical model. In an embodiment of the disclosure, when pre-estimation through the interference prediction unit is insufficient, the gNB may transmit a UL grant related to transmission of a pilot signal for interference estimation to the UL-UE.

The UL-UE receiving the UL grant from the gNB may transmit the pilot signal for interference estimation to the at least one DL-UE (540). The UL-UE may transmit the UL grant received from the gNB to the adjacent cell gNB. The adjacent cell gNB may transmit the pilot signal for interference estimation to the at least one DL-UE.

Referring to FIG. 5B, an example related to operation 500b of FIG. 5A will be described. For example, operation 500b may include at least one operation 530 and at least one operation 540 of FIG. 5A.

The gNB may determine a UL-UE requiring transmission of a pilot signal for interference estimation based on the predicted interference information of the interference prediction unit. For example, based on the predicted interference information, UL-UE C may not require transmission of a pilot signal for interference estimation, and UL-UE A and UL-UE B may require transmission of a pilot signal for interference estimation. A UL grant may not be transmitted to UL-UE C not requiring transmission of a pilot signal for interference estimation, thereby reducing interference estimation overhead.

In FIG. 5B, the gNB may transmit a UL grant related to transmission of a pilot signal for interference estimation to a UL-UE. The gNB may transmit a UL grant to UL-UE A, and UL-UE A may transmit the UL grant to the adjacent cell gNB (532). The gNB may transmit a UL grant to UL-UE B, and UL-UE B may transmit the UL grant to the adjacent cell gNB (534).

The UL-UE and the adjacent cell gNB receiving the UL grant may transmit a pilot signal for interference estimation to the at least one DL-UE. For example, UL-UE A receiving the UL grant may transmit a pilot signal for interference estimation to DL-UE A, DL-UE B, DL-UE C, and the adjacent cell gNB (542). For example, UL-UE B receiving the UL grant may transmit a pilot signal for interference estimation to DL-UE A, DL-UE B, and DL-UE C, and the adjacent cell gNB may transmit a pilot signal for interference estimation to DL-UE C (544).

A signal transmitted by the adjacent cell gNB and/or the UL-UE may act as interference to the DL-UE (560). A signal transmitted by UL-UE A may act as CLI to DL-UE C, and a signal transmitted by the adjacent cell gNB may act as ICI to DL-UE A, DL-UE B, and DL-UE C.

Referring back to FIG. 5A, the gNB may receive an interference measurement report from the DL-UE (550). The DL-UE may receive the interference estimation configuration information from the gNB, and may receive the pilot signal for interference estimation from the UL-UE and/or the adjacent cell gNB. The DL-UE may identify whether the predicted interference information included in the interference estimation configuration information matches interference information obtained based on the pilot signal for interference estimation. For example, when not matched, the DL-UE may transmit an interference measurement report to the gNB.

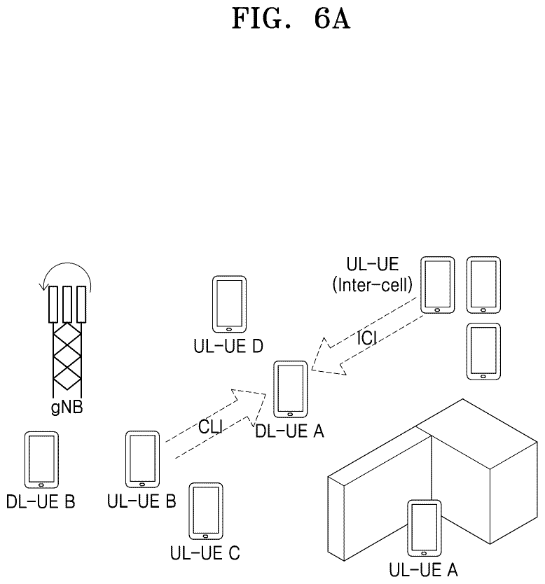

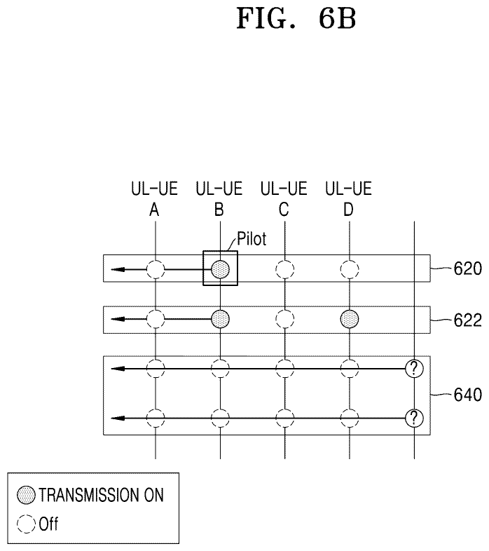

FIGS. 6A and 6B illustrate an interference estimation situation, according to an embodiment.

Referring to FIG. 6A, a wireless communication system may include a gNB, at least one DL-UE (e.g., DL-UE A and DL-UE B), at least one UL-UE (e.g., UL-UE A, UL-UE B, UL-UE C, and UL-UE D), and at least one adjacent cell (inter-cell) UL-UE. An interference prediction unit of the gNB may predict interference information based on cell-site specific information and UE location information. The gNB may transmit interference estimation configuration information obtained based on the predicted interference information to the DL-UE and the UL-UE. For example, because UL-UE A may not cause CLI due to blockage, UL-UE A may be excluded from CLI estimation. For example, because UL-UE B and UL-UE C are located close to each other, only UL-UE B may perform CLI estimation. For example, because UL-UE D and UL-UE B are located far from each other, UL-UE D and UL-UE B may simultaneously perform CLI estimation. For example, because DL-UE B is located at a cell-center and is less affected by ICI from the adjacent cell UL-UE, DL-UE B may be excluded from estimation. Because DL-UE A is located at a cell-edge and is affected by ICI from the adjacent cell UL-UE, DL-UE A may perform estimation.

Referring to FIG. 6B, a UL-UE requiring interference estimation may receive a UL grant from the gNB. The UL-UE receiving the UL grant may transmit a pilot signal for interference estimation to the at least one DL-UE. For example, because UL-UE B and UL-UE C are located close to each other, only UL-UE B may transmit a pilot signal for interference estimation (620). For example, because UL-UE D and UL-UE B are located far from each other, UL-UE D and UL-UE B may simultaneously transmit a pilot signal for interference estimation (622). A signal transmitted by the adjacent cell gNB and/or the adjacent cell UL-UE may act as interference to the DL-UE (640).

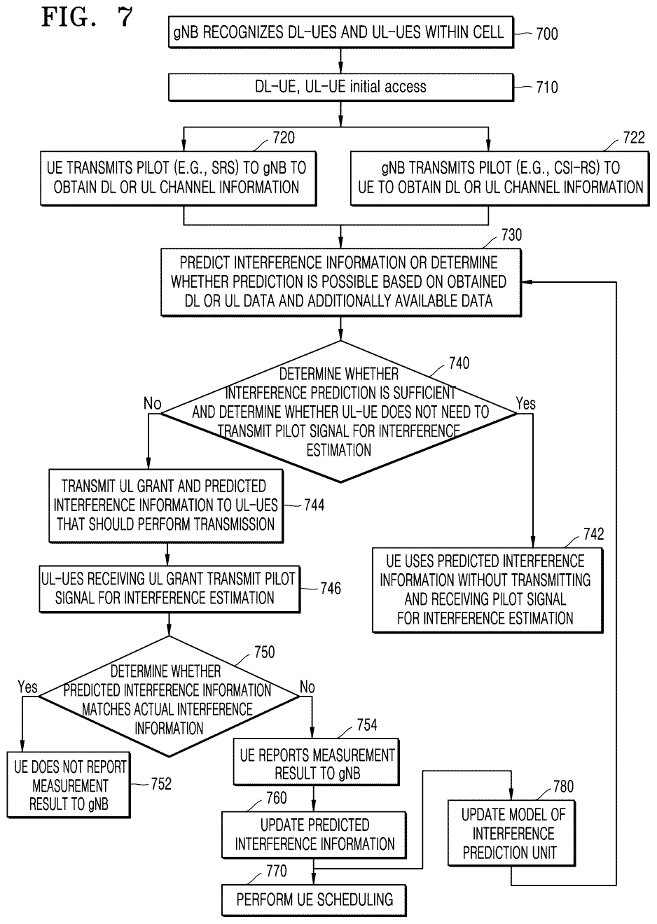

FIG. 7 illustrates an interference estimation method of a BS and a UE, according to an embodiment.

Referring to FIG. 7, an interference estimation method of a gNB including an interference prediction unit, DL-UEs, and UL-UEs will be described.

A gNB may recognize DL-UEs and UL-UEs within a cell (700). A DL-UE and a UL-UE may perform initial access (710). The gNB may receive an initial access-related signal from the DL-UE and/or the UL-UE. The initial access may be performed through beam sweeping. A UE may transmit a pilot (e.g., an SRS) to the gNB to obtain DL or UL channel information (720). The gNB may transmit a pilot (e.g., a CSI-RS) to the UE to obtain DL or UL channel information (722). The gNB may receive a DL-related signal and/or a UL-related signal from UEs.

The gNB may predict interference information or determine whether prediction is possible based on obtained DL or UL data and additionally available data (730). The DL data may include initial access-related information, and a signal transmitted and received between the gNB and the DL-UE in a previous time slot. The UL data may include initial access-related information such as an SRS for UL channel estimation or a RACH, and a signal in a previous time slot. The additionally available data may include MIMO channel angle information such as AoA and AoD, sensing information through ISAC, and vision information (e.g., satellite images and gNB camera images).

Interference information prediction may be performed by an interference prediction unit by using an AI model or a mathematical model. Predicted interference information may be obtained by using the AI model or the mathematical model based on the initial access-related signal and the UL-related signal. The gNB may obtain interference estimation configuration information for the DL-UE and the UL-UE based on the predicted interference information. The interference estimation configuration information including the predicted interference information may be transmitted to the UEs.

The gNB may determine whether interference prediction is sufficient (740). The gNB may determine whether the UL-UE does not need to transmit a pilot signal for interference estimation.

When the gNB determines that the UL-UE does not need to transmit a pilot signal for interference estimation, the UE may use the predicted interference information without transmitting and receiving a pilot signal for interference estimation (742).

When the gNB determines that the UL-UE needs to transmit a pilot signal for interference estimation, the gNB may transmit a UL grant and the predicted interference information to the UL-UEs that should perform transmission (744). The gNB may transmit a UL grant related to transmission of a pilot signal for interference estimation to the UL-UE.

The UL-UEs receiving the UL grant may transmit a pilot signal for interference estimation (746). The UL-UE receiving the UL grant from the gNB may transmit the UL grant to an adjacent cell gNB. The UL-UE receiving the UL grant and the adjacent cell gNB may transmit a pilot signal for interference estimation to at least one DL-UE.

The DL-UE may determine whether the predicted interference information matches actual interference information (750). The DL-UE may determine whether the predicted interference information included in the interference estimation configuration information matches interference information obtained based on the pilot signal for interference estimation.

When the predicted interference information matches the actual interference information, the DL-UE may not transmit an interference measurement report to the gNB (752). When the predicted interference information matches the actual interference information, overhead of the DL-UE having to transmit an interference measurement report to the gNB may be reduced.

When the predicted interference information does not match the actual interference information, the DL-UE may transmit an interference measurement report to the gNB (754). The gNB may update the predicted interference information based on the received interference measurement report (760). The gNB may update the predicted interference information with the actual interference information measured by the DL-UE.

The gNB may perform scheduling for the DL-UE and the UL-UE based on the updated predicted interference information (770). The gNB may update the model of the interference prediction unit by using the updated predicted interference information (780).

The model of the interference prediction unit may be trained by using the updated predicted interference information. For example, operation 730 may be performed through the updated model of the interference prediction unit.

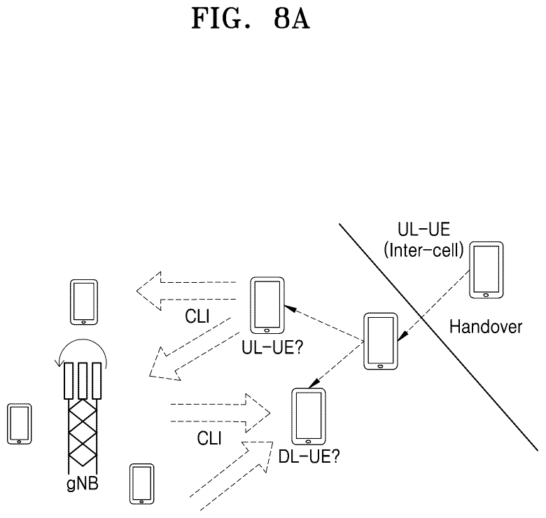

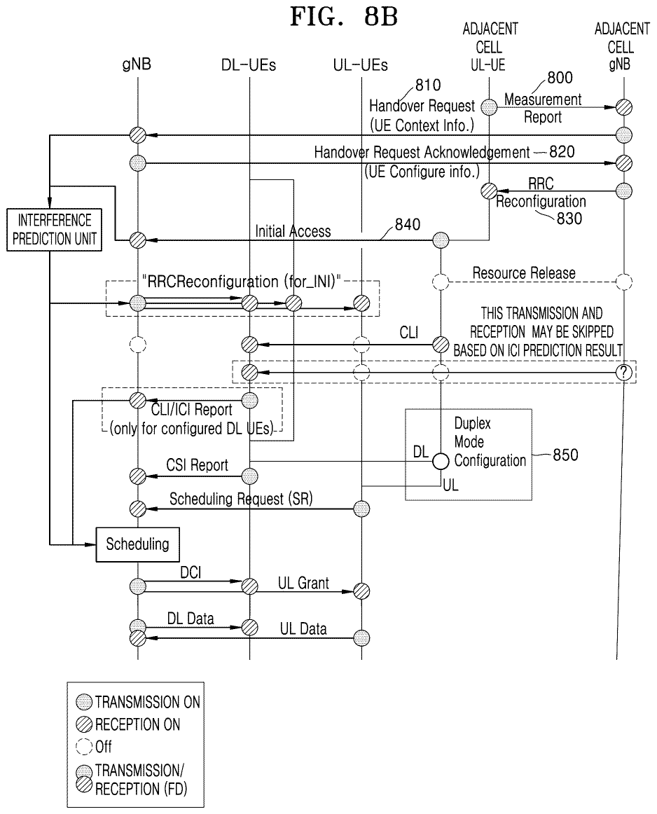

FIGS. 8A and 8B illustrate an interference prediction method related to handover, according to an embodiment.

Referring to FIG. 8A, an adjacent cell (inter-cell) UL-UE may perform handover to a current cell. For example, before the handover, the adjacent cell UL-UE may cause ICI to the current cell. The adjacent cell UL-UE may be handed over as a UL-UE or a DL-UE during a handover process. When handed over as a UL-UE, CLI may be caused to a current cell DL-UE. When handed over as a DL-UE, CLI may be received from the current cell UL-UE. After the handover, re-estimating changed values of ICI and CLI may result in high interference estimation overhead. By utilizing a handover-related signal to estimate changes in CLI and ICI and reflecting the changes in scheduling, interference estimation overhead may be reduced.

Referring to FIG. 8B, an adjacent cell UL-UE may transmit a measurement report to an adjacent cell gNB (800). The measurement report may include information related to a current communication situation.

A gNB may receive a handover-related signal from at least one adjacent cell gNB or UE. An interference prediction unit may obtain predicted interference information based on the handover-related signal, an initial access-related signal, and a UL-related signal. The adjacent cell gNB may transmit a handover request signal to the current cell gNB (810). The handover request signal may include UE context information (e.g., user movement speed, location information, and channel quality). The handover request signal received by the current cell gNB may be input to the interference prediction unit for interference information prediction.

The gNB may transmit a handover request acknowledgement signal to the adjacent cell gNB that has transmitted the handover request signal (820). The handover request acknowledgement signal may include UE configuration information.

The adjacent cell gNB receiving the handover request acknowledgement signal may transmit an RRC reconfiguration signal to the adjacent cell UL-UE requiring handover (830). The adjacent cell UL-UE receiving the RRC reconfiguration signal may perform handover and transmit an initial access-related signal to the current cell gNB as a new UE of the current cell (840). For example, initial access may be performed through beam sweeping. The initial access-related signal received by the current cell gNB may be input to the interference prediction unit for interference information prediction.

The UE handed over to the current cell may be configured as a DL-UE or a UL-UE through duplex mode configuration (850). When configured as a DL-UE, the UE may transmit a CSI report to the gNB. When configured as a UL-UE, the UE may transmit a scheduling request (SR) to the gNB.

Herein, ICI and CLI are changed due to the handover of the adjacent cell UE, and thus, such interference changes may be predicted through the handover-related signal generated during the handover process. For example, when interference changes are accurately predicted through interference information prediction, interference estimation overhead for UEs handed over to the current cell may be reduced.

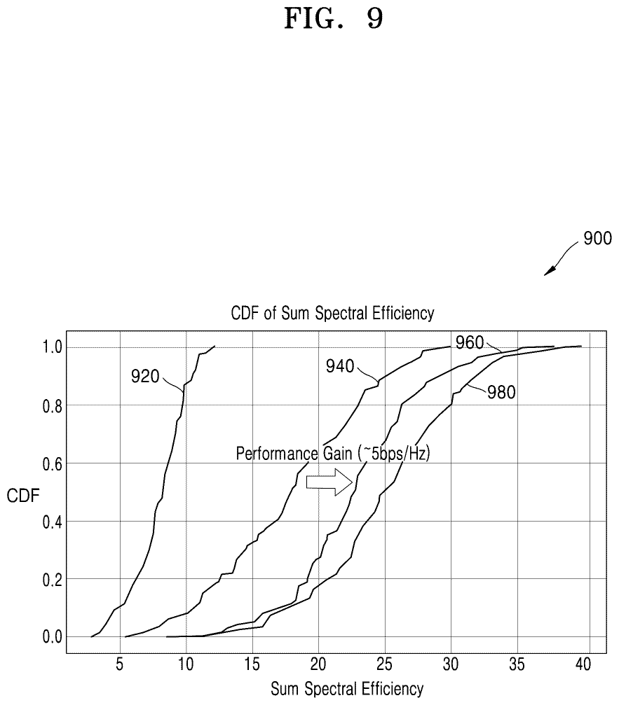

FIG. 9 illustrates an interference estimation simulation result, according to an embodiment.

Referring to FIG. 9, a simulation result 900 of a cumulative distribution function (CDF) of sum spectral efficiency according to a CLI estimation method is shown. For example, FD network scheduling performance and frequency efficiency of UL and DL transmission may be observed. The simulation result 900 includes a half duplex method (920), a method for scheduling using partial CLI information based on cell map data (940), a method for scheduling using predicted interference information (960), and an ideal method assuming that all CLI information is provided to a gNB (980). For example, it is found that the method for scheduling using predicted interference information (960) shows a performance gain of about 5 bps/Hz compared to the method for scheduling using partial CLI information based on cell map data (940). For example, it is found that the method for scheduling using predicted interference information (960) shows a result closer to the ideal method (980) than the method for scheduling using partial CLI information based on cell map data (940).

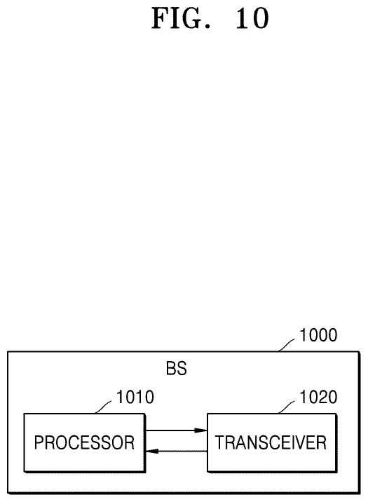

FIG. 10 illustrates a configuration of a BS, according to an embodiment.

Referring to FIG. 10, a BS 1000 may include a processor 1010 and a transceiver 1020.

The BS 1000 may further include a memory in which at least one instruction is stored.

The memory may store various data, programs, or applications for driving and controlling the BS 1000 according to an embodiment. The memory may include, a non-volatile memory including at least one of a flash memory type, a hard disk type, a multimedia card micro type, a card type memory (e.g., SD or XD memory), a read-only memory (ROM), an electrically erasable programmable read-only memory (EPPROM), and a programmable read-only memory (PROM), and a volatile memory such as a random-access memory (RAM) or a static random-access memory (SRAM).

The memory may store instructions, data structures, and program code readable by the processor 1010. In the following embodiments of the disclosure, the processor 1010 may be implemented by executing instructions or code of a program stored in the memory.

The processor 1010 is configured to control a series of processes so that the BS 1000 operates according to embodiments of the disclosure, and the processor 1010 may include one or more processors.

The processor 1010 may include a hardware component for performing arithmetic, logic, and input/output operations and signal processing. The one or more processors included in the processor 1010 may be circuitry such as a system on chip (SoC), an integrated circuit (IC), etc. The processor 1010 may include at least one of, for example, but not limited to, a central processing unit (CPU), a microprocessor, a graphics processing unit (GPU), an application-specific integrated circuit (ASIC), a digital signal processor (DSP), a digital signal processing device (DSPD), a programmable logic device (PLD), or a field-programmable gate array (FPGA).

The processor 1010 may write data to the memory or read data stored in the memory, and particularly, may process data according to predefined operation rules by executing programs or at least one instruction stored in the memory.

The transceiver 1020 may communicate with an external device or a server through at least one wired or wireless communication network under the control of the processor 1010.

The transceiver 1020 may include at least one short-range communication module that performs communication according to a communication standard such as Bluetooth®, Wi-Fi, Bluetooth low energy (BLE), near field communication/radio frequency identification (NFC/RFID), Wifi Direct, ultra wideband (UWB), or ZIGBEE®, and a long-range communication module that communicates with a server for supporting long-range communication according to a long-range communication standard. The long-range communication module may perform communication through a communication network complying with 3G, 4G, 5G, and/or 6G communication standards, or a network for Internet communication.

FIG. 10 illustrates only essential components necessary to describe an operation of the BS 1000, and components included in the BS 1000 are not limited to those illustrated in FIG. 10.

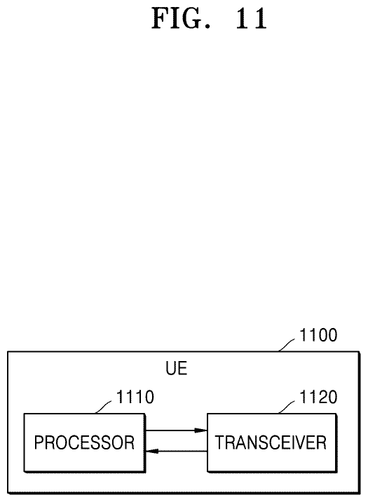

FIG. 11 illustrates a configuration of a UE, according to an embodiment.

Referring to FIG. 11, a UE 1100 may include a processor 1110 and a transceiver 1120.

The UE 1100 may further include a memory in which at least one instruction is stored.

The memory may store various data, programs, or applications for driving and controlling the UE 1100 according to an embodiment. The memory may include, a non-volatile memory including at least one of a flash memory type, a hard disk type, a multimedia card micro type, a card type memory (e.g., SD or XD memory), a ROM, an EPPROM, and a PROM, and a volatile memory such as a RAM or an SRAM.

The memory may store instructions, data structures, and program code readable by the processor 1110. In the following embodiments of the disclosure, the processor 1110 may be implemented by executing instructions or code of a program stored in the memory.

The processor 1110 is configured to control a series of processes so that the UE 1100 operates according to embodiments of the disclosure, and the processor 1110 may include one or more processors.

The processor 1110 may include a hardware component for performing arithmetic, logic, and input/output operations and signal processing. The one or more processors included in the processor 1110 may be circuitry such as a system on chip (SoC), an integrated circuit (IC), etc. The processor 1110 may include at least one of, for example, but not limited to, a CPU, a microprocessor, a GPU, an ASIC, a DSP, a DSPD, a PLD, or an FPGA.

The processor 1110 may write data to the memory or read data stored in the memory, and particularly, may process data according to predefined operation rules by executing programs or at least one instruction stored in the memory.

The transceiver 1120 may communicate with an external device or a server through at least one wired or wireless communication network under the control of the processor 1110.

The transceiver 1120 may include at least one short-range communication module that performs communication according to a communication standard such as Bluetooth®, Wi-Fi, BLE, NFC/RFID, Wifi Direct, UWB, or ZIGBEE®, and a long-range communication module that communicates with a server for supporting long-range communication according to a long-range communication standard. The long-range communication module may perform communication through a communication network complying with 3G, 4G, 5G, and/or 6G communication standards, or a network for Internet communication.

FIG. 11 illustrates only essential components necessary to describe an operation of the UE 1100, and components included in the UE 1100 are not limited to those illustrated in FIG. 11.

The methods according to the claims or the embodiments described herein may be implemented by hardware, software, or a combination of hardware and software.

When the methods are implemented by software, a computer-readable storage medium storing one or more programs (software modules) may be provided. The one or more programs stored in the computer-readable storage medium are configured to be executed by one or more processors in an electronic device. The one or more programs include instructions for allowing the electronic device to execute the methods according to the claims or the embodiments of the disclosure.

The programs (e.g., software modules or software) may be stored in a RAM, a non-volatile memory including a flash memory, a ROM, an EEPROM, a magnetic disc storage device, a CD-ROM, a DVD, another optical storage device, or a magnetic cassette. Alternatively, the programs may be stored in a memory including any combination of some or all of the above storage media. A plurality of constituent memories may be provided.

The programs may be stored in an attachable storage device that is accessible through a communication network, such as the Internet, an intranet, a local area network (LAN), a wide LAN (WLAN), or a storage area network (SAN), or a combination thereof. Such a storage device may access, via an external port, an apparatus for performing an embodiment. A separate storage device on a communication network may access an apparatus for performing an embodiment.

A machine-readable storage medium may be provided as a non-transitory storage medium, which indicates that the storage medium does not include a signal and is tangible, but does not distinguish whether data is stored semi-permanently or temporarily in the storage medium. The non-transitory storage medium may include a buffer in which data is temporarily stored.

The methods according to various embodiments of the disclosure may be provided in a computer program product. The computer program product may be a product purchasable between a seller and a purchaser. The computer program product may be distributed in the form of a machine-readable storage medium (e.g., a CD-ROM), or distributed (e.g., downloaded or uploaded) online via an application store (e.g., Play Store™) or between two user devices (e.g., smartphones) directly. When distributed online, at least part of the computer program product (e.g., a downloadable application) may be temporarily generated or at least temporarily stored in a machine-readable storage medium, such as a memory of a server of a manufacturer, a server of an application store, or a relay server.

As described above, a method performed by a BS in a wireless communication system may be provided.

In the method, the predicted interference information may include at least one of CLI, ICI, or INI.

The method may include transmitting a UL grant related to transmission of a pilot signal for interference estimation to the second UE.

The method may include receiving an interference measurement report from the first UE, in case that the predicted interference information included in the interference estimation configuration information does not match interference information obtained based on the pilot signal for interference estimation.

The method may include updating the predicted interference information based on the interference measurement report.

The method may include performing scheduling for the first UE and the second UE based on the updated predicted interference information.

The method may include training the interference prediction unit by using the updated predicted interference information.

The method may include receiving a handover-related signal from at least one adjacent cell BS or UE. The method, wherein the obtaining of the predicted interference information by the interference prediction unit may include obtaining, by the interference prediction unit, the predicted interference information based on the handover-related signal, an initial access-related signal, and a UL-related signal.

As described above, a BS in a wireless communication system may include a transceiver and at least one processor coupled to the transceiver.

The BS, wherein the predicted interference information may include at least one of CLI, ICI, or INI.

The at least one processor may be configured to transmit a UL grant related to transmission of a pilot signal for interference estimation to the second UE.

The at least one processor may be configured to, when the predicted interference information included in interference estimation configuration information does not match interference information obtained based on the pilot signal for interference estimation, receive an interference measurement report from the first UE.

The at least one processor may be configured to update the predicted interference information based on the interference measurement report.

The at least one processor may be configured to perform scheduling for the first UE and the second UE based on the updated predicted interference information.

The at least one processor may be configured to train the interference prediction unit by using the updated predicted interference information.

The at least one processor may be configured to receive a handover-related signal from at least one adjacent cell BS or UE. The BS, wherein the obtaining of the predicted interference information by the interference prediction unit, may include obtaining, by the interference prediction unit, the predicted interference information based on the handover-related signal, an initial access-related signal, and a UL-related signal.

It should be appreciated that the blocks in each flowchart and combinations of the flowcharts may be performed by one or more computer programs which include computer executable instructions. The one or more computer programs may be stored in a single memory or the one or more computer programs may be divided with different portions stored in different multiple memories.

Any of the functions or operations described herein may be processed by one processor or a combination of processors. One processor or a combination of processors is circuitry performing processing, and may include circuitry such as an application processor (AP), a communication processor (CP), a GPU, a neural processing unit (NPU) a microprocessor unit (MPU), an SoC, or an integrated circuit (IC).

The processor may include various processing circuits and/or a plurality of processors. The term processor used in the specification including the claims may include various processing circuits including at least one processor. In the at least one processor, one or more processors may be configured to perform various functions described herein, individually and/or collectively, in a distributed fashion. As used herein, the processor, at least one processor, and one or more processors may be configured to perform various functions. However, these terms cover, without limitation, a situation where one processor performs some of functions and other processors perform others of the functions, and a situation where a single processor may perform all functions. The at least one processor may include a combination of processors for performing various functions of disclosed functions in a distributed fashion. The at least one processor may execute program instructions to achieve or perform various functions.

Elements included herein are expressed as singular or plural according to the embodiments of the disclosure. However, singular or plural expressions are selected for convenience of description, and the disclosure is not limited to singular or plural components. The components expressed as plural may be configured as a single component, or a component expressed as singular may be configured as plural components.

Herein, each block of flowchart illustrations and combinations of blocks in the flowchart illustrations may be implemented by computer program instructions. Because these computer program instructions may be loaded into a processor of a general-purpose computer, special purpose computer, or other programmable data processing equipment, the instructions, which are executed via the processor of the computer or other programmable data processing equipment generate means for performing the functions specified in the flowchart block(s).

Because these computer program instructions may also be stored in a computer-executable or computer-readable memory that may direct the computer or other programmable data processing equipment to function in a particular manner, the instructions stored in the computer-executable or computer-readable memory may produce an article of manufacture including instruction means for performing the functions stored in the flowchart block(s). Because the computer program instructions may also be loaded into a computer or other programmable data processing equipment, a series of operational steps may be performed on the computer or other programmable data processing equipment to produce a computer implemented process, and thus, the instructions executed on the computer or other programmable data processing equipment may provide steps for implementing the functions specified in the flowchart block(s).

Each block may represent a module, segment, or portion of code, which includes one or more executable instructions for implementing specified logical function(s). It should also be noted that in some alternative implementations, the functions noted in the blocks may occur out of the order. Two blocks shown in succession may in fact be executed substantially concurrently or the blocks may sometimes be executed in reverse order, according to the functionality involved.

While the disclosure has been illustrated and described with reference to various embodiments of the present disclosure, those skilled in the art will understand that various changes can be made in form and detail without departing from the spirit and scope of the present disclosure as defined by the appended claims and their equivalents.

What is claimed is:

1. A method performed by a base station in a wireless communication system, the method comprising:
receiving an initial access-related signal from a first terminal;
receiving an uplink (UL)-related signal from a second terminal;
obtaining, by an interference prediction unit, predicted interference information based on the initial access-related signal and the UL-related signal;
obtaining interference estimation configuration information for the first terminal and the second terminal based on the predicted interference information; and
transmitting the interference estimation configuration information comprising the predicted interference information to the first terminal and the second terminal.

2. The method of claim 1,
wherein the predicted interference information comprises at least one of cross-link interference (CLI), inter-cell interference (ICI), or inter-node interference (INI).

3. The method of claim 1, further comprising:
transmitting a UL grant related to transmission of a pilot signal for interference estimation to the second terminal.

4. The method of claim 3, further comprising:
in case that the predicted interference information included in the interference estimation configuration information does not match interference information obtained based on the pilot signal for interference estimation, receiving an interference measurement report from the first terminal.

5. The method of claim 4, further comprising:
updating the predicted interference information based on the interference measurement report.

6. The method of claim 5, further comprising:
performing scheduling for the first terminal and the second terminal based on the updated predicted interference information.

7. The method of claim 5, further comprising:
training the interference prediction unit by using the updated predicted interference information.

8. The method of claim 1, further comprising:
receiving a handover-related signal from at least one adjacent cell base station or terminal,
wherein the interference prediction unit obtains the predicted interference information based on the handover-related signal, the initial access-related signal, and the UL-related signal.

9. A base station in a wireless communication system, the base station comprising:
a transceiver; and
at least one processor coupled to the transceiver,
wherein the at least one processor is configured to:
receive an initial access-related signal from a first terminal,
receive an uplink (UL)-related signal from a second terminal,
obtain, by an interference prediction unit, predicted interference information based on the initial access-related signal and the UL-related signal,
obtain interference estimation configuration information for the first terminal and the second terminal based on the predicted interference information, and
transmit the interference estimation configuration information comprising the predicted interference information to the first terminal and the second terminal.

10. The base station of claim 9,
wherein the predicted interference information comprises at least one of cross-link interference (CLI), inter-cell interference (ICI), or inter-node interference (INI).

11. The base station of claim 9, wherein the at least one processor is further configured to:
transmit a UL grant related to transmission of a pilot signal for interference estimation to the second terminal.

12. The base station of claim 11, wherein the at least one processor is further configured to:
in case that the predicted interference information included in the interference estimation configuration information does not match interference information obtained based on the pilot signal for interference estimation, receive an interference measurement report from the first terminal.

13. The base station of claim 12, wherein the at least one processor is further configured to:
update the predicted interference information based on the interference measurement report.

14. The base station of claim 13, wherein the at least one processor is further configured to:
perform scheduling for the first terminal and the second terminal based on the updated predicted interference information.

15. The base station of claim 13, wherein the at least one processor is further configured to:
train the interference prediction unit by using the updated predicted interference information.

16. The base station of claim 9, wherein the at least one processor is further configured to:
receive a handover-related signal from at least one adjacent cell base station or terminal,
wherein the interference prediction unit obtains the predicted interference information based on the handover-related signal, the initial access-related signal, and the UL-related signal.

17. A method performed by a first terminal in a wireless communication system, the method comprising:
transmitting an initial access-related signal to a base station,
wherein predicted interference information is obtained by an interference prediction unit in the base station based on the initial access-related signal and an uplink (UL)-related signal transmitted from a second terminal, and interference estimation configuration information for the first terminal and the second terminal is obtained in the base station based on the predicted interference information; and
receiving the interference estimation configuration information comprising the predicted interference information from the base station.

18. A first terminal in a wireless communication system, the first terminal comprising:
a transceiver; and
at least one processor coupled to the transceiver,
wherein the at least one processor is configured to:
transmit an initial access-related signal to a base station,
wherein predicted interference information is obtained by an interference prediction unit in the base station based on the initial access-related signal and an uplink (UL)-related signal transmitted from a second terminal, and interference estimation configuration information for the first terminal and the second terminal is obtained in the base station based on the predicted interference information, and
receive the interference estimation configuration information comprising the predicted interference information from the base station.
